(19) United States
(12) Patent Application Publication
(10) Pub. No.: US 2011/0286662 A1
(43) Pub. Date: Nov. 24, 2011

(54) SYSTEM FOR BUILDING A PERSONALIZED-CHARACTER DATABASE AND METHOD THEREOF

(76) Inventor: Jung-Chi Lai, Taoyuan County (TW)

(21) Appl. No.: 13/110,920

(22) Filed: May 19, 2011

(30) Foreign Application Priority Data
May 21, 2010 (TW) 099116281

(51) Int. Cl. G06K 9/62

(52) U.S. Cl. 382/161

(57) ABSTRACT

Input personal handwriting of a character stored in a system character database into an input device. Divide the personal handwriting of the character into a group of personalized roots. Store the group of personalized roots in a personalized-root database. Form a plurality of personalized characters according to a plurality of personalized roots stored in the personalized-root database. Store the plurality of personalized characters in a personalized-character database.

### BACKGROUND OF THE INVENTION

1. Field of the Invention

The present invention is related to a system for building a character database and a method thereof, and more particularly, to a system for building a personalized character database and a method thereof.

2. Description of the Prior Art

As technology advances, web interfaces and electronic devices emphasizing personalization have gradually become a trend. For instance, personal web pages, blogs, mobile phones, personal digital assistants (PDA) and tablet PCs can all utilize fonts, background colors and/or images provided by a manufacturer or vendor to achieve customization.

Most users utilize a combination of the font, the background color and/or the image provided by the manufacturer or vendor to achieve customization, such that a visual difference can be attained by changing the image. However, to truly distinguish personalized characteristics, elements or habits related to the user should also be involved, so the user is not just combining the font, the background color and/or the image provided by the manufacturer or vendor passively.

Therefore, the manufacturer or vendor must take a different approach to provide personalized design tools, for the user to create a personalized interface involving personal elements or habits.

### SUMMARY OF THE INVENTION

The present invention discloses a method for building a personalized character database. The method comprises inputting personal handwriting of a character stored in a system character database into an input device; dividing the personal handwriting of the character into a group of personalized roots; storing the group of personalized roots in a personalized root database; forming a plurality of personalized characters according to a plurality of personalized roots stored in the personalized root database; and storing the plurality of personalized characters in the personalized character database.

The present invention further discloses a system for building a personalized character database. The system comprises a memory, an input device and a font processing module. The memory comprises a personalized root database and a personalized character database. The input device is for allowing a user to input personal handwriting of a character stored in a system character database into the input device. The font processing module is for dividing the personal handwriting of the character into a group of personalized roots, storing the group of personalized roots in the personalized root database, forming a plurality of personalized characters according to a plurality of personalized roots stored in the personalized root database, and storing the plurality of personalized characters in the personalized character database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system for building a personalized character database according to an embodiment of the present invention.

FIG. 2 and FIG. 3 are diagrams illustrating the input device comprising the plurality of detecting regions.

FIG. 4 is a diagram illustrating a flow chart of a method for building a personalized character database, according to another embodiment of the present invention.

FIG. 5 is a diagram illustrating the font processing module dividing the personal handwriting of the character with multi-characteristics into a group of personalized roots, and then forming the personalized roots into other characters.

### DETAILED DESCRIPTION

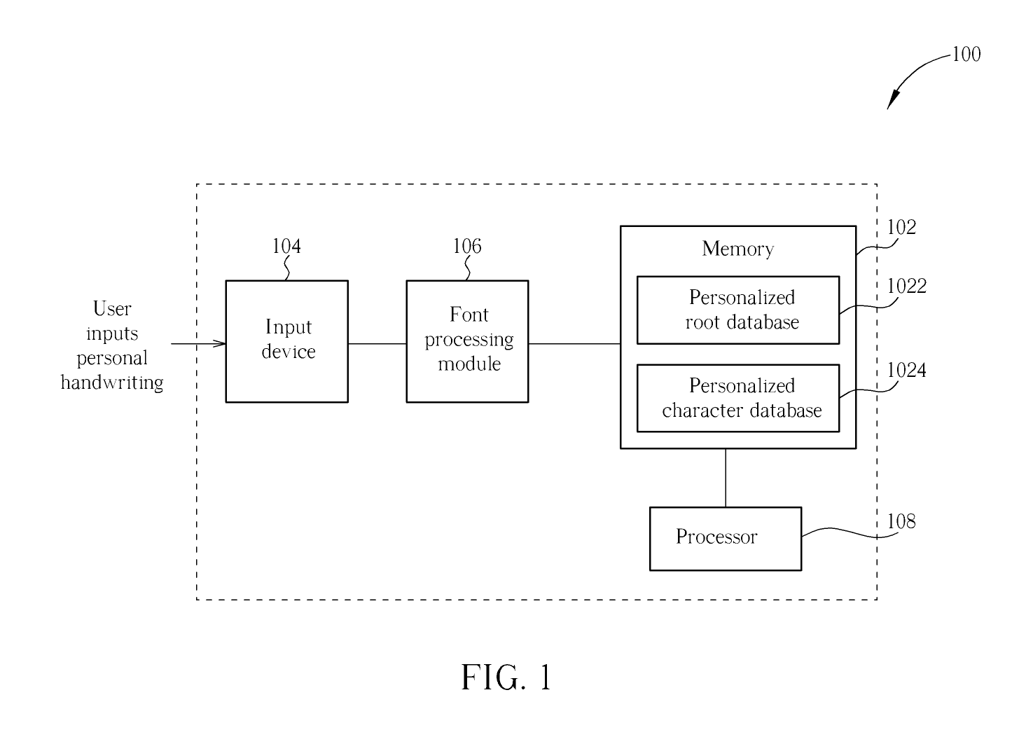

Please refer to FIG. 1. FIG. 1 is a diagram illustrating a system 100 for building a personalized character database according to an embodiment of the present invention. The system 100 comprises a memory 102, an input device 104, a font processing module 106 and a processor 108.

The memory 102 comprises a personalized character root database 1022 and a personalized character database 1024. The input device 104 is coupled to the font processing module 106, for allowing the user to input personal handwriting of a character stored in a system character database into the input device 104. A font of the character stored in the system character database, for instance, can be Times New Roman, Arial or other common font. The font processing module 106 is coupled to the memory 102 and the processor 108, for dividing the personal handwriting of the character, which is analyzed in a plurality of detecting regions of the input device 104, into a group of personalized roots, and then storing the group of personalized roots in the personalized root database 1022. On the other hand, the font processing module 106 forms a plurality of personalized characters according to a plurality of personalized roots stored in the personalized root database 1022 and stores the plurality of personalized characters in the personalized character database 1024.

The processor 108 is coupled to the memory 102, for replacing a character displayed according to the character stored in the system character database with the personalized characters stored in the personalized character database 1024. Further, the processor 108 also establishes a file transfer format, for an electronic device without the personalized character database 1024 to be able to display the personalized characters stored in the personalized character database 1024. In addition, the processor 108 is able to transfer a file possessing the personalized characters stored in the personalized character database 1024 to the electronic device which does not have the personalized character database 1024.

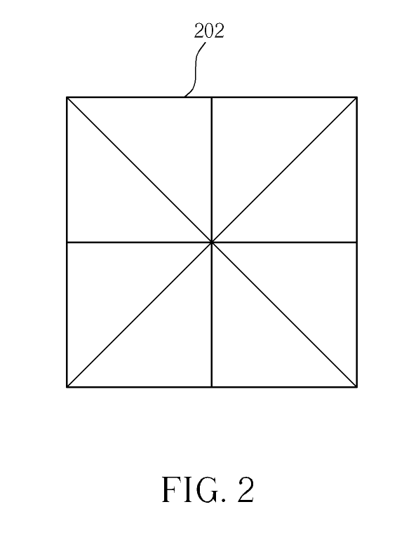

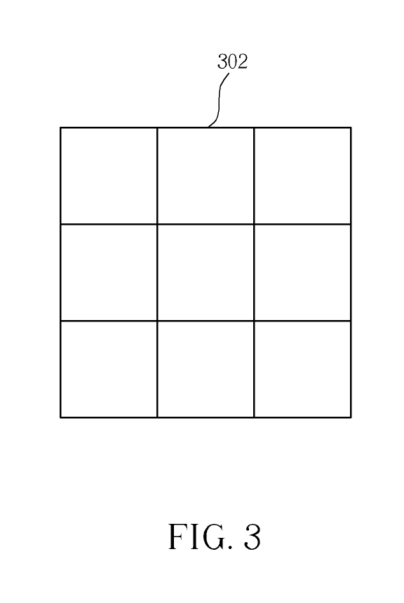

Please refer to FIG. 2 and FIG. 3. FIG. 2 and FIG. 3 are diagrams illustrating the input device comprising the plurality of detecting regions. As shown in FIG. 2, the plurality of detecting regions of the input device 202 are “*” shaped. As shown in FIG. 3, the plurality of detecting regions of the input device 302 are 3×3 grids. However, the plurality of detecting regions of the input device of the present invention are not limited to being “*” shaped or 3×3 grids. As long as the input device comprises a plurality of detecting regions, such characteristics fall within the scope of the present invention.

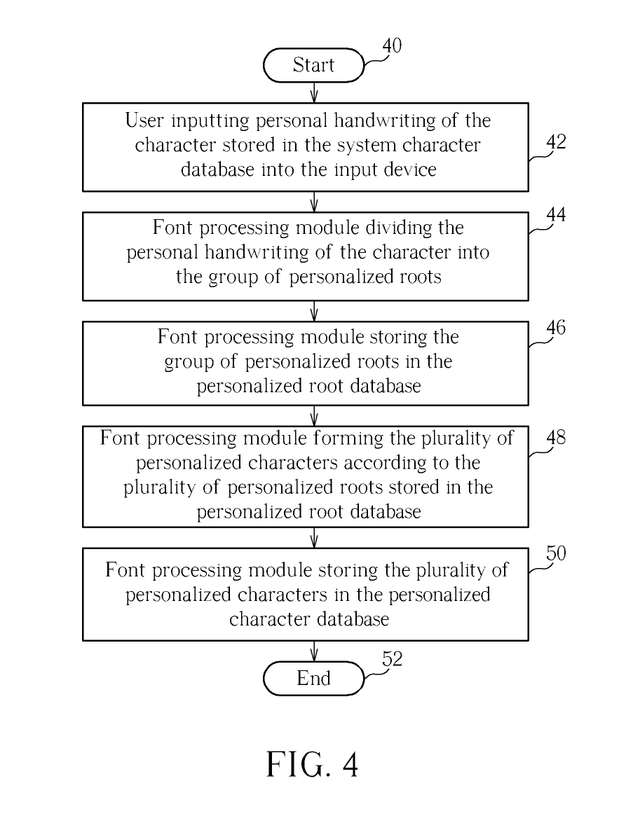

Please refer to FIG. 4. FIG. 4 is a diagram illustrating a flow chart of a method for building a personalized character database, according to another embodiment of the present invention. For exemplary purposes, the method in FIG. 4 is explained in accordance with the system 100 in FIG. 1. The steps of the method are detailed below, and include:

Step 40: start;

Step 42: a user inputting personal handwriting of the character stored in the system character database into the input device 104;

Step 44: the font processing module 106 dividing the personal handwriting of the character into the group of personalized roots;

Step 46: the font processing module 106 storing the group of personalized roots in the personalized root database 1022;

Step 48: the font processing module 106 forming the plurality of personalized characters according to the plurality of personalized roots stored in the personalized root database 1022;

Step 50: the font processing module 106 storing the plurality of personalized characters in the personalized character database 1024;

Step 52: end.

The personalized character database 1024 does not have any personalized characters stored at first. In the step 42, according to the character with multiple characteristics provided by the system, the user inputs the personal handwriting corresponding to the character to an input device 104. The input device 104, for instance, can be a pen tablet, a touch pad, a mouse or a scanner, but is not limited to these. Further, the characters the user can input are not limited to the ones provided by the system, but the user can also input personal handwriting of other characters with multiple characteristics, according to practical demands.

In the step 44, the font processing module 106 analyzes the personal handwriting corresponding to the character in the plurality of detecting regions of the input device 104, so as to divide the personal handwriting of the character into the group of personalized roots. Then, in the step 46, the font processing module 106 stores the personalized roots in the personalized root database 1022. In the step 48, the font processing module 106 forms the plurality of personalized characters according to the plurality of personalized roots stored in the personalized root database 1022. In the step 50, the font processing module 106 stores the plurality of personalized characters in the personalized character database 1024.

In addition, when the personalized character database 1024 begins storing the plurality of personalized characters, the user can choose whether to replace the character displayed (e.g. character displayed according to the character stored in the system character database) with the personalized characters stored in the personalized character database 1024 or not. The processor 108 can establish a file transfer format, so as to allow the electronic device without the personalized character database 1024 to be able to display the personalized characters stored in the personalized character database 1024. Accordingly, the processor 108 transfers the file which possesses the personalized characters stored in the personalized character database 1024 to the electronic device which does not have the personalized character database 1024.

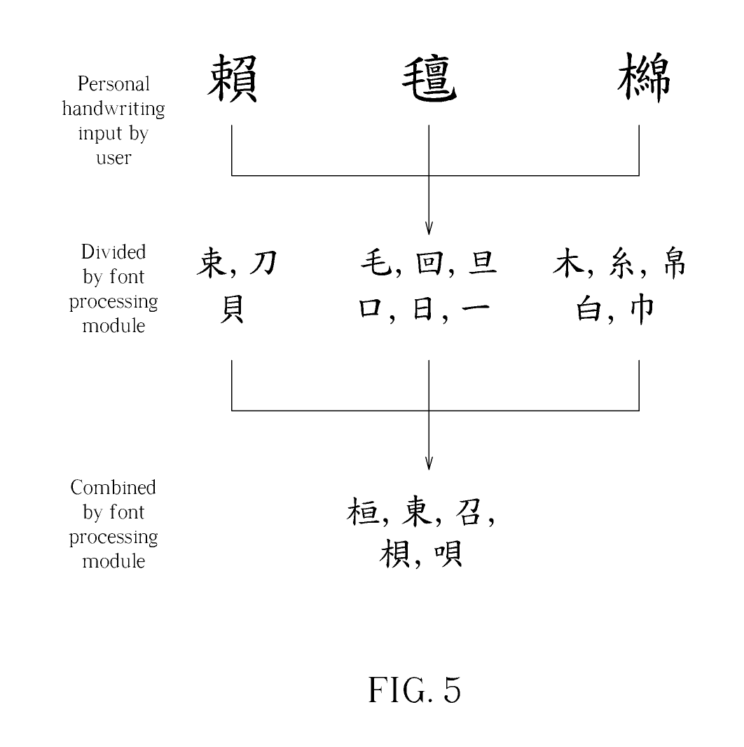

Please refer to FIG. 5. FIG. 5 is a diagram illustrating the font processing module 106 dividing the personal handwriting of the character with multiple characteristics into a group of personalized roots, and then forming the personalized roots into other characters. For instance, the user inputs the personal handwriting of characters “ [symbol] ”, “ [symbol] ”, and “ [symbol] ” into the input device 104. The font processing module 106 divides the personal handwriting of the character of “ [symbol] ” into personalized roots of “ [symbol] ”, “ [symbol] ” and “ [symbol] ”. The font processing module 106 divides the personal handwriting of the character of “ [symbol] ” into personalized roots of “ [symbol] ”, “ [symbol] ”, “□”, “ [symbol] ”, “ [symbol] ” and “-”. The font processing module 106 divides the personal handwriting of the character “ [symbol] ” into personalized roots of “ [symbol] ”, “ [symbol] ”, “ [symbol] ”, “ [symbol] ” and “ [symbol] ”. The font processing module 106 can then recombine the personalized roots obtained above into other personalized characters such as “ [symbol] ”, “ [symbol] ”, “ [symbol] ”, “ [symbol] ” and “ [symbol] ”, etc.

When the font processing module 106 combines the personalized roots into other personalized characters, the personalized root database 1022 must possess the personalized roots corresponding to all roots of the personalized character to be generated; otherwise, the font processing module 106 will not perform combining of the personalized roots into other personalized characters. For instance, a character of “ [symbol] ” consists of roots “ [symbol] ” and “□”. If the personalized root database 1022 only has the root “ [symbol] ” or “□” stored, the font processing module 106 will not perform combining, so the personalized character database 1024 will not have the personalized character “ [symbol] ”.

In summary, as the user inputs more characters via the input device 104, more personalized characters are stored in the personalized character database 1024. This way, web interfaces and electronic devices, for instance, with personalized features can be achieved. The present invention can also establish a file transfer format, for electronic devices not having the personalized character database 1024 to display the personalized characters stored in the personalized character database 1024.

Those skilled in the art will readily observe that numerous modifications and alterations of the device and method may be made while retaining the teachings of the invention.

What is claimed is:

1. A method for building a personalized character database, comprising:
inputting personal handwriting of a character stored in a system character database into an input device;
dividing the personal handwriting of the character into a group of personalized roots;
storing the group of personalized roots in a personalized root database;
forming a plurality of personalized characters according to a plurality of personalized roots stored in the personalized root database; and
storing the plurality of personalized characters in the personalized character database.

2. The method of claim 1, wherein dividing the personal handwriting of the character into the group of personalized roots is analyzing the personal handwriting of the character in a plurality of detecting regions, for dividing the personal handwriting of the character into the group of personalized roots.

3. The method of claim 1, further comprising:
replacing a character displayed according to the character stored in the system character database with the personalized characters stored in the personalized character database.

4. The method of claim 3, further comprising:
establishing a file transfer format, for an electronic device not having the personalized character database to be able to display the personalized characters stored in the personalized character database; and
transferring a file possessing the personalized characters stored in the personalized character database to the electronic device.

5. A system for building a personalized character database, comprising:
a memory, comprising a personalized root database and a personalized character database;
an input device, for allowing a user to input personal handwriting of a character stored in a system character database into the input device; and
a font processing module, for dividing the personal handwriting of the character into a group of personalized roots, storing the group of personalized roots in the personalized root database, forming a plurality of personalized characters according to a plurality of personalized roots stored in the personalized root database, and storing the plurality of personalized characters in the personalized character database.

6. The system of claim 5, wherein the input device comprises a plurality of detecting regions for analyzing the personal handwriting of the character in the plurality of detecting regions, so as to divide the personal handwriting of the character into the group of personalized roots.

7. The system of claim 5, further comprising:
a processor, for replacing a character displayed according to the character stored in the system character database with the personalized characters stored in the personalized character database; establishing a file transfer format, for an electronic device not having the personalized character database to be able to display the personalized characters stored in the personalized character database; and transferring a file possessing the personalized characters stored in the personalized character database to the electronic device.

8. The system of claim 5, wherein the input device comprises a plurality of detecting regions.

9. The system of claim 8, wherein the plurality of detecting regions are “*” shaped detecting regions.

10. The system of claim 8, wherein the plurality of detecting regions are 3×3 grids.
